(19) United States
(12) Patent Application Publication
(10) Pub. No.: US 2007/0186243 A1
(43) Pub. Date: Aug. 9, 2007

(54) System and method of providing television program recommendations

(75) Inventors: Scott A. Pettit, San Antonio, TX (US); Mary McCarthy, San Antonio, TX (US); Anthony A. Haeuser, Aurora, IL (US); Chris Lee, San Antonio, TX (US); Roland Noll, San Antonio, TX (US)

Correspondence Address: TOLER SCHAFFER, LLP, 8500 BLUFFSTONE COVE, SUITE A201, AUSTIN, TX, 78759, US

(73) Assignee: SBC Knowledge Ventures, LP, Reno, NV (US)

(21) Appl. No.: 11/349,881

(22) Filed: Feb. 8, 2006

(51) Int. Cl. H04N 5/445; H04N 7/10; H04N 7/025; G06F 3/00; G06F 13/00

(52) U.S. Cl. 725/46; 725/34; 725/35

(57) ABSTRACT

A system and method of providing television program recommendations is disclosed. In a particular embodiment, the method includes receiving a user review of a television program from a set-top box device via an access network of an Internet Protocol Television (IPTV) system. The method also includes associating the user review with a user of the set-top box device. The method also includes receiving a request for programming recommendations from the set-top box device and generating a recommendation list that includes at least one recommended program.

### FIELD OF THE DISCLOSURE

The present disclosure is generally related to providing television program recommendations.

### BACKGROUND

Technological advancements in television and video transmission services have enabled content providers to offer viewers a broad range of entertainment. For example, evolutions from broadcast transmission, to off-air broadcasting, to cable and satellite transmissions have allowed content providers to increase programming from fifty channels to over five hundred channels. The increase in the number of available channels allows viewers to watch their favorite types of content, such as sports, comedy, news, and documentaries, at nearly any time of day, simply by switching to a channel that is dedicated to the content type or by requesting on-demand content.

The quantity and variety of content that content providers offer can make choosing a program difficult. In many cases, viewers may wish to receive programming recommendations. In the past, recommendations have been based on ratings of the most popular television programming that are sampled and published by research organizations. These publications are available weeks or even months after a program airs. Thus, the ratings services are unlikely to help a particular viewer decide what to watch at a given time. Accordingly, there is a need for an improved system and method of providing television program recommendations.

### BRIEF DESCRIPTION OF THE DRAWINGS

FIG. 1 is a block diagram illustrating an embodiment of an Internet Protocol Television (IPTV) system;

FIG. 2 is a block diagram illustrating an embodiment of a system to receive television programming recommendations;

FIG. 3 is a flow diagram illustrating an embodiment of a method of providing television programming recommendations;

FIG. 4 is a flow diagram illustrating a second embodiment of a method of providing television programming recommendations;

FIG. 5 is a flow diagram illustrating a method of receiving television programming recommendations;

FIG. 6 is a diagram of an illustrative embodiment of a graphical user interface to provide television program recommendations;

FIG. 7 is a diagram of a second illustrative embodiment of a graphical user interface to provide television program recommendations;

FIG. 8 is a diagram of an illustrative embodiment of a graphical user interface to receive a user review;

FIG. 9 is a diagram of an illustrative embodiment of a graphical user interface to provide television programming recommendations;

FIG. 10 is a diagram of a second illustrative embodiment of a graphical user interface to provide television programming recommendations;

FIG. 11 is a diagram of a third illustrative embodiment of a graphical user interface to provide television programming recommendations;

FIG. 12 is a diagram of an illustrative embodiment of a graphical user interface to receive user-defined preferences; and

FIG. 13 is a diagram of an illustrative embodiment of a general computer system.

### DETAILED DESCRIPTION OF THE DRAWINGS

A system to provide television program recommendations is disclosed and includes a server within an Internet Protocol Television (IPTV) system, the server having a processor and a memory device accessible to the processor. The memory device includes a user store that is configured to store a review of a television program received from a set-top box device and to associate the review with a user of the set-top box device. The memory device includes a recommendation engine that is executable by the processor to generate a recommendation list that includes at least one recommended program. The server is configured to transmit the recommendation list to the set-top box device via an access network of the IPTV system.

In another embodiment, a system to receive television program recommendations is disclosed and includes a set-top box having a processor and a memory device accessible to the processor. The memory device includes a review module that is executable by the processor to submit a user review of a television program to a server via an Internet Protocol Television (IPTV) system, where the review is associated with the user. The memory device includes a recommendation module that is executable by the processor to issue a request via the IPTV system to receive programming recommendations. The recommendation module is configured to transmit a recommendation list to a display device coupled to the set-top box device, the recommendation list including at least one recommended program.

In another embodiment, a method of providing television program recommendations is disclosed and includes receiving a user review of a television program from a set-top box device via an access network of an Internet Protocol Television (IPTV) system. The method also includes associating the user review with a user of the set-top box device. The method also includes receiving a request for programming recommendations from the set-top box device and generating a recommendation list that includes at least one recommended program.

In another embodiment, a method of receiving television program recommendations is disclosed and includes submitting a user review of a television program to a server via an access network of an Internet Protocol Television (IPTV) system, where the review is associated with the user at the server. The method also includes issuing a request for programming recommendations to the server via the access network and receiving a recommendation list via the access network, where the recommendation list includes at least one recommended program.

In another embodiment, a computer program embedded in a computer-readable medium is disclosed and includes instructions to store a review of a television program received from a set-top box device and to associate the review with a user of the set-top box device. The computer program also includes instructions to generate a recommendation list that includes at least one recommended program, in response to a request for programming recommendations received from the set-top box device. The computer program also includes instructions to transmit the recommendation list to the set-top box device via an access network of an Internet Protocol Television (IPTV) system.

In another embodiment, a computer program embedded in a computer-readable medium is disclosed and includes instructions to submit a user review of a television program to a server via an access network of an Internet Protocol Television (IPTV) system. The computer program also includes instructions to issue a request to the server via the access network to receive programming recommendations. The computer program also includes instructions to transmit a recommendation list received from the server to a display device coupled to the set-top box device, the recommendation list including at least one recommended program.

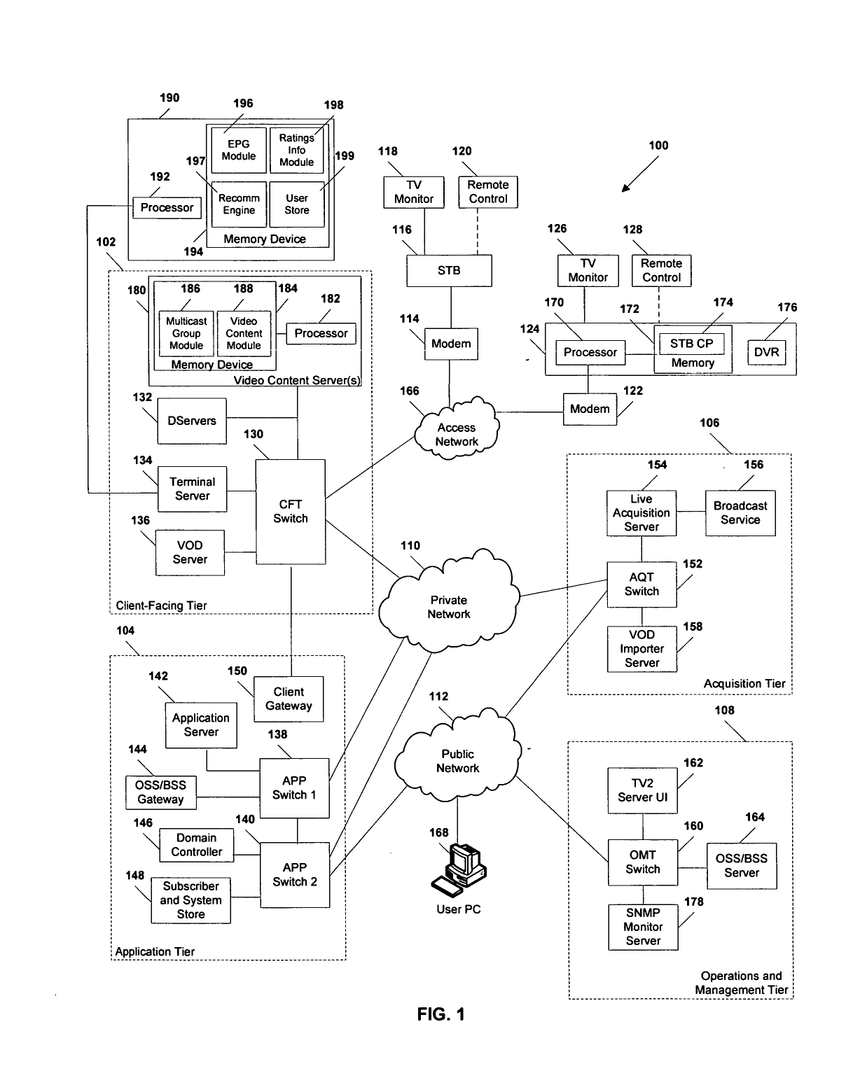

Referring to FIG. 1, an illustrative embodiment of an Internet Protocol Television (IPTV) system that may be used to provide television program recommendations is illustrated and is generally designated 100. As shown, the system 100 can include a client facing tier 102, an application tier 104, an acquisition tier 106, and an operations and management tier 108. Each tier 102, 104, 106, 108 is coupled to a private network 110; to a public network 112, such as the Internet; or to both the private network 110 and the public network 112. For example, the client-facing tier 102 can be coupled to the private network 110. Further, the application tier 104 can be coupled to the private network 110 and to the public network 112. The acquisition tier 106 can also be coupled to the private network 110 and to the public network 112. Additionally, the operations and management tier 108 can be coupled to the public network 112.

As illustrated in FIG. 1, the various tiers 102, 104, 106, 108 communicate with each other via the private network 110 and the public network 112. For instance, the client-facing tier 102 can communicate with the application tier 104 and the acquisition tier 106 via the private network 110. The application tier 104 can also communicate with the acquisition tier 106 via the private network 110. Further, the application tier 104 can communicate with the acquisition tier 106 and the operations and management tier 108 via the public network 112. Moreover, the acquisition tier 106 can communicate with the operations and management tier 108 via the public network 112. In a particular embodiment, elements of the application tier 104, including, but not limited to, a client gateway 150, can communicate directly with the client-facing tier 102.

As illustrated in FIG. 1, the client-facing tier 102 can communicate with user equipment via an access network 166, such as an Internet Protocol Television (IPTV) access network. In an illustrative embodiment, modems, such as a first modem 114 and a second modem 122 can be coupled to the access network 166. The client-facing tier 102 can communicate with a first representative set-top box device 116 via the first modem 114 and with a second representative set-top box device 124 via the second modem 122. The client-facing tier 102 can communicate with a large number of set-top boxes, such as the representative set-top boxes 116, 124, over a wide geographic area, such as a regional area, a metropolitan area, a viewing area, a designated market area or any other suitable geographic area, market area, or subscriber or customer group that can be supported by networking the client-facing tier 102 to numerous set-top box devices. In an illustrative embodiment, the client-facing tier 102, or any portion thereof, can be included at a video head-end office.

In a particular embodiment, the client-facing tier 102 can be coupled to the modems 114, 122 via fiber optic cables. Alternatively, the modems 114, 122 can be digital subscriber line (DSL) modems that are coupled to one or more network nodes via twisted pairs, and the client-facing tier 102 can be coupled to the network nodes via fiber-optic cables. Each set-top box device 116, 124 can process data received via the access network 166, via an IPTV software platform, such as Microsoft® TV IPTV Edition.

Additionally, the first set-top box device 116 can be coupled to a first external display device, such as a first television monitor 118, and the second set-top box device 124 can be coupled to a second external display device, such as a second television monitor 126. Moreover, the first set-top box device 116 can communicate with a first remote control 120, and the second set-top box device can communicate with a second remote control 128. The set-top box devices 116, 124 can include IPTV set-top box devices; video gaming devices or consoles that are adapted to receive IPTV content; personal computers or other computing devices that are adapted to emulate set-top box device functionalities; any other device adapted to receive IPTV content and transmit data to an IPTV system via an access network; or any combination thereof.

In an exemplary, non-limiting embodiment, each set-top box device 116, 124 can receive video content, which may include video and audio portions, from the client-facing tier 102 via the access network 166. The set-top boxes 116, 124 can transmit the video content to an external display device, such as the television monitors 118, 126. Further, the set-top box devices 116, 124 can each include a STB processor, such as STB processor 170, and a STB memory device, such as STB memory 172, which is accessible to the STB processor 170. In one embodiment, a computer program, such as the STB computer program 174, can be embedded within the STB memory device 172. Each set-top box device 116, 124 can also include a video content storage module, such as a digital video recorder (DVR) 176. In a particular embodiment, the set-top box devices 116, 124 can communicate commands received from the remote control devices 120, 128 to the client-facing tier 102 via the access network 166.

In an illustrative embodiment, the client-facing tier 102 can include a client-facing tier (CFT) switch 130 that manages communication between the client-facing tier 102 and the access network 166 and between the client-facing tier 102 and the private network 110. As shown, the CFT switch 130 is coupled to one or more data servers, such as D-servers 132, that store, format, encode, replicate, or otherwise manipulate or prepare video content for communication from the IPTV system 100 to the set-top box devices 116, 124. The CFT switch 130 can also be coupled to a terminal server 134 that provides terminal devices, such as a program information server 190, with a connection point to the private network 110. In a particular embodiment, the CFT switch 130 can also be coupled to a video-on-demand (VOD) server 136 that stores or provides VOD content imported by the IPTV system 100.

In a particular embodiment, the CFT switch 130 can also be coupled to one or more video content servers 180. The video content server(s) 180 can include a cluster of video content servers, such as a group of multicast video content servers. Each video content server 180 includes a processor 182 and a memory device 184. In one embodiment, the memory device 184 of each video content server 180 can include one or more modules 186, 188 that are executable by the processor 182. For example, the memory device 184 of each video content server 180 can include a multicast group module 186 executable by the processor 182 to manipulate multicast groups in response to join commands or leave commands issued by the set-top box devices 116, 124. Additionally, the memory device 184 of each video content server 180 can include a video content module 186 executable by the processor 182 to provide video content of a channel to the set-top boxes 116, 124 within one or more multicast groups.

As illustrated in FIG. 1, the application tier 104 can communicate with both the private network 110 and the public network 112. The application tier 104 can include a first application tier (APP) switch 138 and a second APP switch 140. In a particular embodiment, the first APP switch 138 can be coupled to the second APP switch 140. The first APP switch 138 can be coupled to an application server 142 and to an OSS/BSS gateway 144. In a particular embodiment, the application server 142 can provide applications to the set-top box devices 116, 124 via the access network 166, which enable the set-top box devices 116, 124 to provide functions, such as display, messaging, processing of IPTV data and VOD material, etc. In a particular embodiment, the OSS/BSS gateway 144 includes operation systems and support (OSS) data, as well as billing systems and support (BSS) data. In one embodiment, the OSS/BSS gateway 144 can provide or restrict access to an OSS/BSS server 164 that stores operations and billing systems data.

Further, the second APP switch 140 can be coupled to a domain controller 146 that provides Internet access, for example, to users via the public network 112. For example, the domain controller 146 can provide remote Internet access to IPTV account information, e-mail, personalized Internet services, or other online services via the public network 112. Users can access such information or services using their personal computers 168. The second APP switch 140 can be coupled to a subscriber and system store 148 that includes account information, such as account information that is associated with users who access the system 100 via the private network 110 or the public network 112. Additionally, the second APP switch 140 can be coupled to one or more interactive voice response (IVR) servers 182 that can communicate with a user telephone 184 via the public network 112.

In a particular embodiment, the application tier 104 can also include a client gateway 150 that communicates data directly with the client-facing tier 102. In this embodiment, the client gateway 150 can be coupled directly to the CFT switch 130. The client gateway 150 can provide or restrict access to the private network 110 and the tiers coupled thereto.

In a particular embodiment, the set-top box devices 116, 124 can access the IPTV system 100 via the access network 166, using information received from the client gateway 150. In this embodiment, the access network 166 can provide security for the private network 110. User devices can access the client gateway 150 via the access network 166, and the client gateway 150 can allow such devices to access the private network 110 once the devices are authenticated or verified. Similarly, the client gateway 150 can prevent unauthorized devices, such as hacker computers or stolen set-top box devices from accessing the private network 110, by denying access to these devices beyond the access network 166.

For example, when the first representative set-top box device 116 accesses the system 100 via the access network 166, the client gateway 150 can verify subscriber information by communicating with the subscriber and system store 148 via the private network 110, the first APP switch 138, and the second APP switch 140. Further, the client gateway 150 can verify billing information and status by communicating with the OSS/BSS gateway 144 via the private network 110 and the first APP switch 138. In one embodiment, the OSS/BSS gateway 144 can transmit a query via the first APP switch 138, to the second APP switch 140, and the second APP switch 140 can communicate the query via the public network 112 to the OSS/BSS server 164. After the client gateway 150 confirms subscriber and/or billing information, the client gateway 150 can allow the set-top box device 116 to access IPTV content and VOD content. If the client gateway 150 cannot verify subscriber information for the set-top box device 116, e.g., because it is connected to an unauthorized twisted pair, the client gateway 150 can block transmissions to and from the set-top box device 116 beyond the access network 166.

As indicated in FIG. 1, the acquisition tier 106 includes an acquisition tier (AQT) switch 152 that communicates with the private network 110. The AQT switch 152 can also communicate with the operations and management tier 108 via the public network 112. In a particular embodiment, the AQT switch 152 can be coupled to a live acquisition server 154 that receives or acquires television or movie content, for example, from a broadcast service 156. In a particular embodiment, the live acquisition server 154 can transmit the television or movie content to the AQT switch 152, and the AQT switch 152 can transmit the television or movie content to the CFT switch 130 via the private network 110.

Further, the television or movie content can be transmitted to the D-servers 132, where it can be encoded, formatted, stored, replicated, or otherwise manipulated and prepared for communication to the set-top box devices 116, 124. The CFT switch 130 can receive the television or movie content from the D-servers 132 and communicate the content to the modems 114, 122 via the access network 166. The set-top box devices 116, 124 can receive the television or movie content via the modems 114, 122, and can transmit the television or movie content to the television monitors 118, 126. In an illustrative embodiment, video or audio portions of the television or movie content can be streamed to the set-top box devices 116, 124.

Further, the AQT switch can be coupled to a video-on-demand importer server 158 that stores television or movie content received at the acquisition tier 106 and communicates the stored content to the VOD server 136 at the client-facing tier 102 via the private network 110. Additionally, at the acquisition tier 106, the video-on-demand (VOD) importer server 158 can receive content from one or more VOD sources outside the IPTV system 100, such as movie studios and programmers of non-live content. The VOD importer server 158 can transmit the VOD content to the AQT switch 152, and the AQT switch 152, in turn, can communicate the material to the CFT switch 130 via the private network 110. The VOD content can be stored at one or more servers, such as the VOD server 136.

When users issue requests for VOD content via the set-top box devices 116, 124, the requests can be transmitted over the access network 166 to the VOD server 136, via the CFT switch 130. Upon receiving such requests, the VOD server 136 can retrieve the requested VOD content and transmit the content to the set-top box devices 116,124 across the access network 166, via the CFT switch 130. The set-top box devices 116, 124 can transmit the VOD content to the television monitors 118, 126. In an illustrative embodiment, video or audio portions of VOD content can be streamed to the set-top box devices 116, 124.

FIG. 1 further illustrates that the operations and management tier 108 can include an operations and management tier (OMT) switch 160 that conducts communication between the operations and management tier 108 and the public network 112. In the embodiment illustrated by FIG. 1, the OMT switch 160 is coupled to a TV2 server 162. Additionally, the OMT switch 160 can be coupled to an OSS/BSS server 164 and to a simple network management protocol (SNMP) monitor 170 that monitors network devices within or coupled to the IPTV system 100. In a particular embodiment, the OMT switch 160 can communicate with the AQT switch 152 via the public network 112.

In an illustrative embodiment, the live acquisition server 154 can transmit the television or movie content to the AQT switch 152, and the AQT switch 152, in turn, can transmit the television or movie content to the OMT switch 160 via the public network 112. In this embodiment, the OMT switch 160 can transmit the television or movie content to the TV2 server 162 for display to users accessing the user interface at the TV2 server 162. For example, a user can access the TV2 server 162 using a personal computer (PC) 168 coupled to the public network 112.

In a particular embodiment, a user can issue a request to a set-top box device, such as the second representative set-top box device 124, to view an electronic program guide (EPG). The set-top box processor 170 can be configured to transmit the request to a program information server 190 via the CFT switch 130. The memory device 194 of the program information server 190 can include an EPG module 196 that is executable by the processor 192 to generate the EPG and transmit the EPG to the set-top box device 124 over the access network 166. The set-top box device 124 can receive the EPG via a modem 122, for example, and transmit the EPG to a television monitor 126 that is coupled to the set-top box device 124.

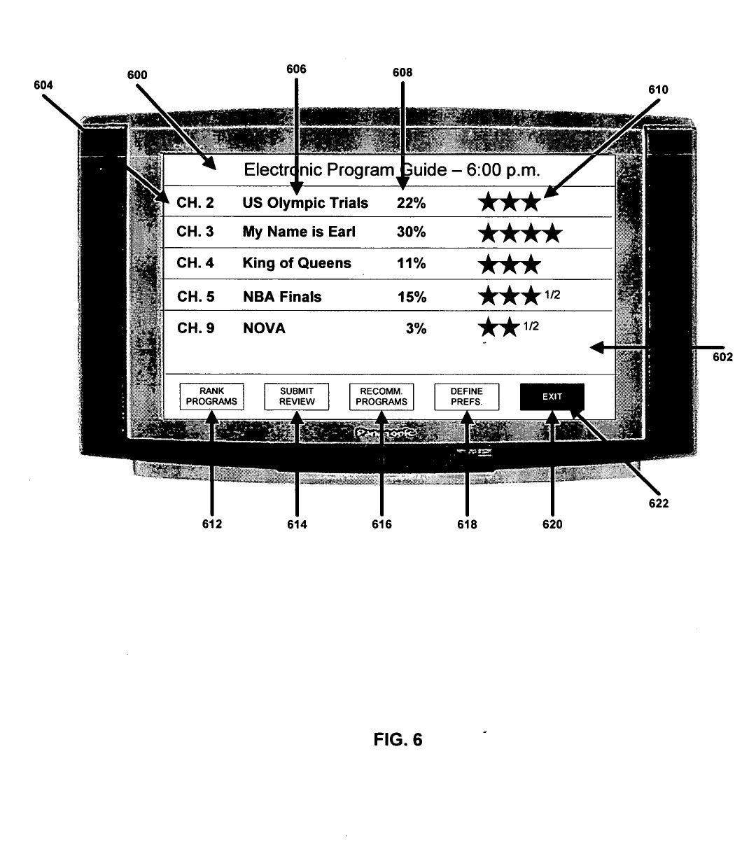

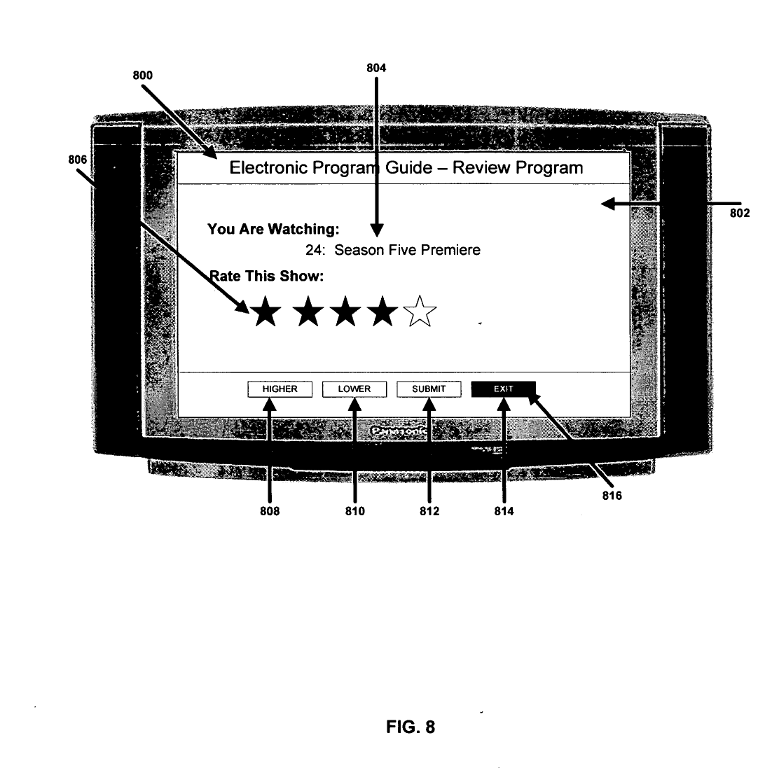

In a particular embodiment, the program information server 190 can maintain reviews of one or more programs by associating reviews received from individual set-top boxes 116, 124 with users of the set-top boxes 116, 124 at the user store 199. A user can submit a review, for instance, by pressing a review submission key on a remote control 128. Alternatively, the EPG can include a first indicator of a first selectable option to submit a review, such as that illustrated at 614 in FIG. 6. A user can select the indicator using a remote control 128, for example, and the set-top box device can transmit a prompt for the review to the display device 126. An example embodiment of a graphical user interface to prompt a user to submit a review is illustrated in FIG. 8.

The user can input a review of the program, such as a number of stars, and the set-top box device 124 can transmit the review to the program information server 190. The review can be stored in the user store 199. In a particular embodiment, the review can also be stored at the ratings information module 198 and can be used to calculate an average review of the program that is stored in the ratings information module 198.

In an illustrative embodiment, the EPG can include a second indicator of a second selectable option to receive program recommendations from the program information server 190. A user can issue a command to receive the program recommendations, for example, by pressing a recommend programming button on a remote control 128 or by using a remote control 128 to select a soft button displayed on the EPG, such as that illustrated at 616 in FIG. 6. The program information server memory device 194 can include a recommendation engine 197 that is executable by the processor 192 to generate a recommendation list that includes at least one recommended program and to transmit the recommendation list to the set-top box device 124.

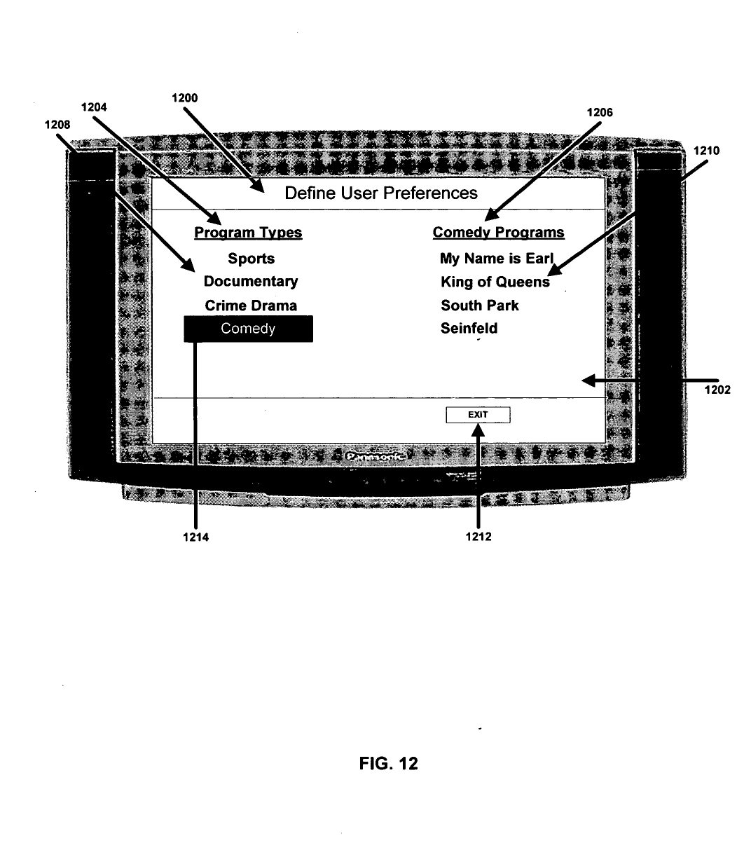

In a particular embodiment, the recommendation engine 197 can generate the recommendation list by comparing one or more programs, to be shown within a period of time after the user issues the request for program recommendations, with user-defined preferences stored at the user store 199. For example, the user can set programming preferences, such as preferences for actors, program types, program genres, sport teams, or any combination thereof, by using the personal computer (PC) 168 to communicate with the user store 199 via a web portal maintained by the domain controller 146. In another embodiment, the user can set programming preferences, such as preferences for actors, program types, program genres, sport teams, or any combination thereof, via the electronic program guide (EPG) or other graphical user interface (GUI) suitable to enter user-defined preferences. An example of a GUI suitable to allow a user to enter user-defined preferences is illustrated in FIG. 12.

In another particular embodiment, the recommendation engine 197 can generate the recommendation list by identifying programs that the user has watched and rated during a certain time before the request. The recommendation engine 197 can determine which programs the user gave a threshold rating to, e.g., three stars or greater, during a period of time before the request. The recommendation engine can also identify other users whose reviews are stored at the user store 199 and who gave the threshold rating to the same program. The recommendation engine can determine which other program(s) the other users also rated at or above the threshold rating or a different threshold rating. The recommendation list generated by the recommendation engine 197 can include such other program(s).

In an illustrative, non-limiting embodiment, the recommendation engine 197 can generate the recommendation list by identifying programs that the user has watched and rated during a certain time before the request. The recommendation engine 197 can determine which programs the user gave a threshold rating to, e.g., three stars or greater, during a period of time before the request. The recommendation engine can identify other program(s) being shown during a certain period of time after the request, which share a program type, actor, sport team, or any combination thereof, with the programs that received the threshold rating from the user. The recommendation list generated by the recommendation engine 197 can include such other program(s).

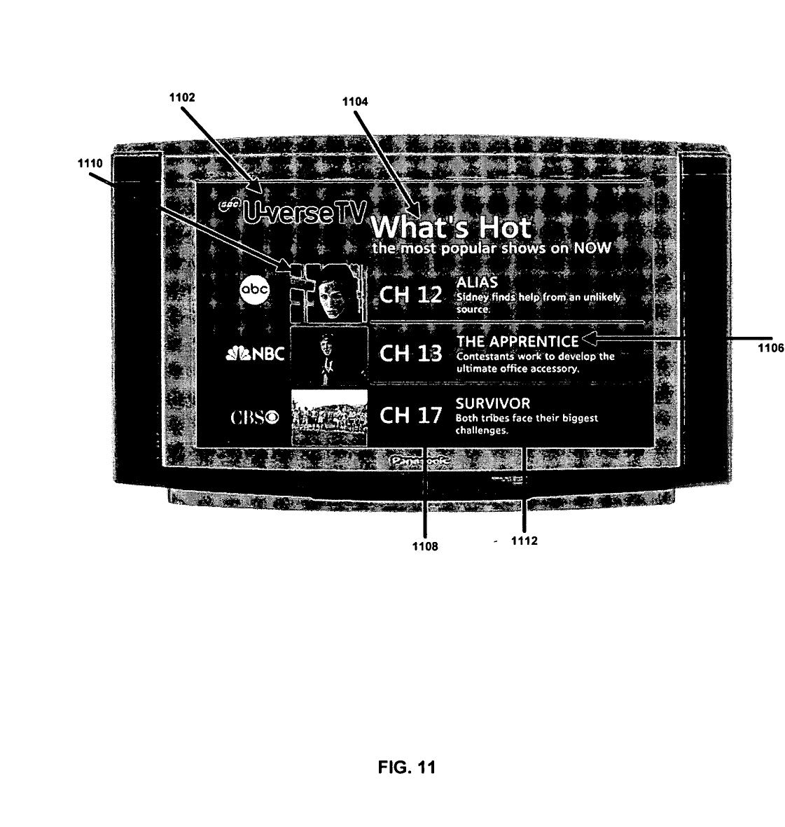

In another illustrative embodiment, the recommendation engine 197 can generate the recommendation list by aggregating program viewing across a user base, such as a nationwide area, region, state, metropolitan area, neighborhood, or other market area. The recommendation engine 197 can measure audience data related to various television channels or programs, for example, by measuring multicast groups associated with each channel or by determining what programming is being called down from the access network 166 by each set-top box device 116, 124. The recommendation engine can recommend programs having the highest aggregated audience data during a past period of minutes, hours, days, or weeks. For example, the recommendation list can include a “What's Hot” list, such as that illustrated in FIG. 11.

In another illustrative embodiment, the recommendation engine 197 can generate the recommendation list by aggregating program viewing across a user base and data mining program viewing associated with a single user or set-top box device. The user store 199 can log television program viewing by a user or at a set-top box device during a period of time before the request for television program recommendations. The recommendation engine 197 can measure audience data related to various television channels or programs and compare the audience data to the logged television program viewing of the user. The recommendation engine 197 can generate the recommendation list by determining whether programs having the highest audience data match any programs regularly viewed at the set-top box device. The recommendation list can include such matching programs.

In a particular embodiment, the recommendation engine 197 can generate the recommendation list by data mining program viewing associated with a single user or the set-top box device. The user store 199 can log television program viewing by a user or at a set-top box device during a period of time before the request for television programming recommendations. The recommendation engine 197 can generate the recommendation list by determining whether programs regularly viewed by the user or at the set-top box device are currently showing or will be shown during a period of time after the request for television program recommendations. The recommendation list can include such programs; other programs that share-a genre, actor, program type, sport team, or any combination thereof, with such programs; or any combination of such programs and other programs.

In another illustrative embodiment, the EPG can include a third indicator of a third selectable option to view real-time ratings information related to one or more programs displayed on the EPG. If the user desires to review real-time ratings information, the user can issue a command to receive the real-time ratings information, for example, by pressing a ratings information button on a remote control 128 or by using a remote control 128 to select a soft button displayed on the EPG. The set-top box device 124 can issue a request for the real-time ratings information to the program information server 190. The program information server memory device 194 can include a ratings information module 198 that is executable by the processor 192 to acquire real-time ratings information from the video content servers 180 and to transmit an updated EPG having the real-time ratings information to the set-top box device 124 for display at the television monitor 126.

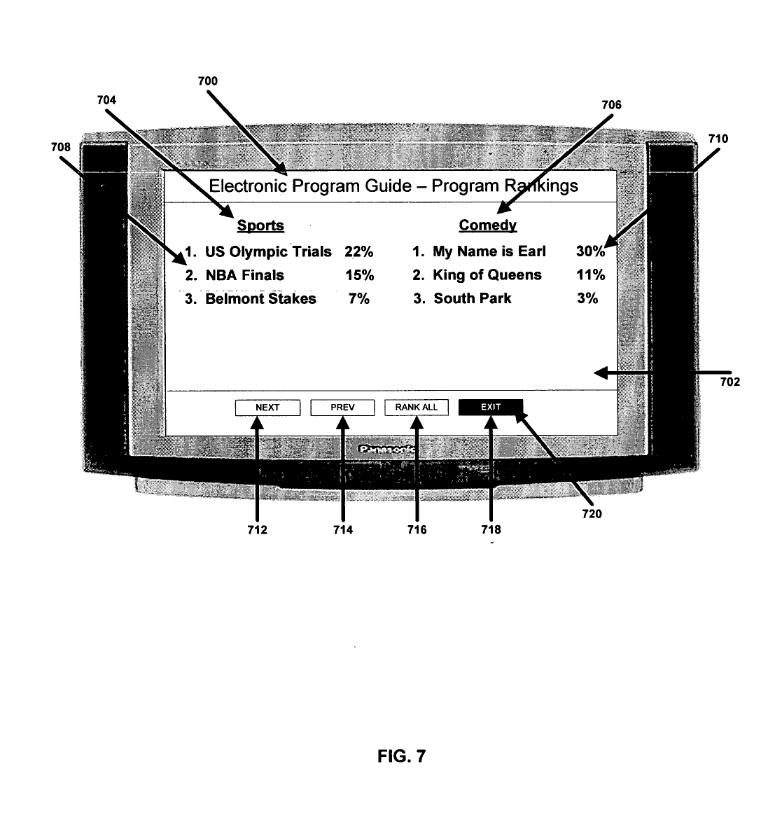

In a particular embodiment, the real-time ratings information can include audience data related to the program(s), such as a number or percentage of set-top boxes within a nationwide area, region, state, metropolitan area, neighborhood, or other market area, which are receiving each program. Alternatively, the audience data can also be a statistical estimation of total viewers, based on the number of set-top devices receiving each program. In another embodiment, the real-time ratings information can include reviews of one or more programs displayed on the EPG. A review can be, for example, an average review submitted from set-top boxes within an area that are receiving or have received a program. In an illustrative embodiment, each review can be expressed as one or more integers, such as ‘9 out of 10’ or as a number of stars, such as ‘4 out of 5 stars.’ An example embodiment of an EPG having real-time ratings information is illustrated further in FIG. 7.

In an illustrative embodiment, the program information server 190 can obtain audience data for a program by determining the number of set-top boxes in a multicast group of a channel that is carrying the program. Each time that a join command or leave command is issued by a set-top box device 116, 124 that changes to or from a channel, the number of set-top boxes in the multicast group of the channel can be updated at a multicast group module 186 of the video content server 180 that is supplying the video content carried by the channel. In a particular embodiment, the ratings information module 198 of the program information server 190 can be executable by the processor to determine the number of set-top boxes in the multicast group of each channel displayed by the EPG, e.g., by retrieving data from each video content server 180, at periodic time intervals or when a request for real-time ratings information is received.

In an illustrative embodiment, the EPG can include a fourth indicator of a fourth selectable option to receive program rankings based on audience data or reviews. The set-top box device 124 can receive a selection of the indicator from the user via the remote control 128 and transmit a request for program rankings to the program information server 190. The program information server 190 can compare audience data for various programs, for instance, by comparing the sizes of multicast groups of channels carrying the programs, and the program information server 190 can arrange the programs into a ranked list. The program information server 190 can transmit the ranked list to the set-top box device 124. In an illustrative embodiment, the user may issue a command to the program information server 190, via the set-top box device 124, to segment the rankings by program type, such as sports, comedy, drama, action, news, documentary, educational, movie, or another program type. An example embodiment of a graphical user interface to display ranked programs is illustrated further in FIG. 7.

In an alternative embodiment, a user can issue a request to the set-top box device 124 to view the electronic program guide (EPG). The set-top box processor 170 can be configured to request data related to the EPG from the program information server 190. The program information server 190 can transmit the data to the set-top box device 124 in response to the request. The memory device 172 of the set-top box device 124 can include a computer program 174 that is executable by the set-top box processor 170 to generate the EPG and transmit the EPG to the television monitor 126.

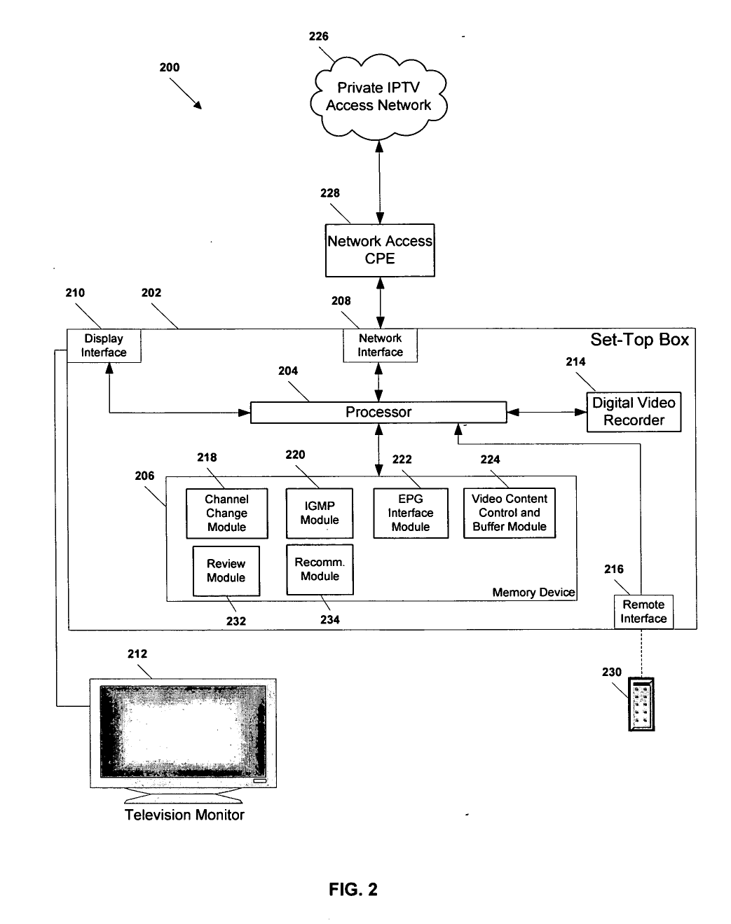

Referring to FIG. 2, an embodiment of a system to receive television program recommendations is illustrated and designated generally at 200. The system includes a set-top box 202 that contains a processor 204 and a memory device 206 that is accessible to the processor 204. Additionally, the processor 204 can be coupled to a network interface 208. Further, the processor 204 can be coupled to a display interface 210, such as a television interface, through which the set-top box device 202 can communicate video content, television ratings information, or other content or graphics to an external display device, such as a television monitor 212. In addition, the processor 204 can communicate with a remote control device 230, via a remote control interface 216.

The processor 204 can communicate with an external access network, such as an Internet Protocol Television (IPTV) access network 226, via the network interface 208. In an illustrative, non-limiting embodiment, the IPTV access network 226 can be the access network 166 illustrated in FIG. 1. In a particular embodiment, network access customer premises equipment (CPE) 228 can facilitate communication between the network interface 208 and the IPTV access network 226. The network access CPE 228 can include a router, a local area network device, a modem, such as a digital subscriber line (DSL) modem, any other suitable device for facilitating communication between the network interface 208 of the set-top box device 202 and the IPTV access network 226, or any combination thereof. In an illustrative, non-limiting embodiment, the network access CPE 228 can be the modem 114 or 122 illustrated in FIG. 1.

In a particular embodiment, the memory device 206 can include a channel change module 218. The channel change module 218 can be executable by the processor 204 to receive a channel change request from a user, for example, via the remote control device 230. In an illustrative embodiment, the memory device 206 can also include an Internet Group Management Protocol (IGMP) module 220 that is executable by the processor 204 to issue a join command to a server within an IPTV system via the IPTV access network 226, in response to the channel change request. The join command can be a command to be added to a multicast group of a requested channel. In a particular embodiment, the IGMP module 220 can also be executable by the processor 204 to issue a leave command to the server within the IPTV system, in response to the channel change request, to be removed from a multicast group of the channel from which the user requests a change.

The memory device 206 can include an electronic program guide (EPG) interface module 222 that is executable by the processor 204 to receive and process a request for an EPG from a user. In a particular embodiment, the EPG interface module 222 can be executable by the processor 204 to request an EPG from a server within the IPTV system and to receive the EPG via the IPTV access network 226. In another particular embodiment, the EPG interface module 222 can be executable by the processor 204 to request data related to an EPG from a server within the IPTV system and to generate the EPG at the set-top box device 202. The EPG interface module 222 can be executable by the processor 204 to transmit the EPG to the television monitor 212 via the display interface 210.

In an illustrative embodiment, the EPG can include a first indicator of a first selectable option to submit a review of a program. A user can select the indicator using the remote control 230, for example, and the set-top box device can transmit a prompt for the review to the television monitor 212. The prompt can be a graphical user interface (GUI) suitable to allow the user to enter a review, such as the GUI illustrated in FIG. 8. In one embodiment, the prompt or GUI can be received via the access network 226 by the set-top box device 202. Alternatively, the set-top box device can include a review module 232 executable by the processor 204 to generate the prompt or GUI. In another embodiment, the EPG module 222 can be executable by the processor 204 to generate the prompt or GUI. The user can input a review of the program, such as a number of stars, and the set-top box device 202 can transmit the review to a server via the access network 226. In an illustrative, non-limiting embodiment, the server can be the program information server 190 illustrated in FIG. 1. The review can be associated with the user or the set-top box device 202 and stored in a user store at the server.

In an illustrative embodiment, the EPG can include a second indicator of a second selectable option to receive program recommendations. A user can issue a command to receive the program recommendations, for example, by pressing a recommend programming button on the remote control 230 or by using the remote control 230 to select a soft button displayed on the EPG. The set-top box device 202 can transmit a request for program recommendations to a server via the access network 226 in response to the command. The set-top box device 202 can receive a recommendation list via the access network 226 that includes at least one recommended program and can transmit the recommendation list to the television monitor 212. In one embodiment, the set-top box memory device 206 can include a recommendation module 234 that is executable by the processor 204 to generate a request for program recommendations and to transmit the request to the server. The recommendation module 234 can also be executable by the processor 204 to process data related to a recommendation list received via the access network 226 and to generate a display or GUI that includes the recommendation list for transmission to the television monitor 212.

In another illustrative embodiment, the EPG can include a third indicator of a third selectable option to view real-time ratings information, such as audience data and average reviews related to programs included in the EPG. The EPG interface module 222 can be executable by the processor 204 to receive a selection of the indicator from the remote control device 230, for example, and to provide the real-time ratings information via an updated EPG having the real-time ratings information, such as that illustrated in FIG. 6. In one embodiment, the EPG interface module 222 can be executable by the processor 204 to request the updated EPG from a server within an IPTV system and to receive the updated EPG via the IPTV access network 226. In another embodiment, the EPG interface module 222 can be executable by the processor 204 to request data related to the real-time ratings information from a server within the IPTV system and to generate the updated EPG having the real-time ratings information at the set-top box device 202.

In an illustrative embodiment, the EPG or updated EPG can include a fourth indicator of a fourth selectable option to view program rankings, for example, according to audience data. Additionally, the EPG or updated EPG can include a fifth indicator of a fifth selectable option to view program rankings that are segmented by program type. The EPG interface module 222 can be executable by the processor 204 to receive a selection to view segmented or non-segmented program rankings and to transmit a request for the program rankings to a server within the IPTV system. Further, the EPG interface module 222 can be executable by the processor 204 to receive the segmented or non-segmented program rankings from the server via the IPTV access network 226 and to transmit the program rankings to the television monitor 212 via the display interface 210. In an alternative embodiment, the EPG interface module 222 can be executable by the processor 204 to generate the program rankings based on data related to the real-time ratings information that the set-top box 202 received via the IPTV access network 226.

The memory device 206 can also include a video content control and buffer module 224 that is executable by the processor 204 to receive multicast video content carried over a channel requested by a user and to buffer the video content before transmitting it to the display interface 210, in order to prevent underflow.

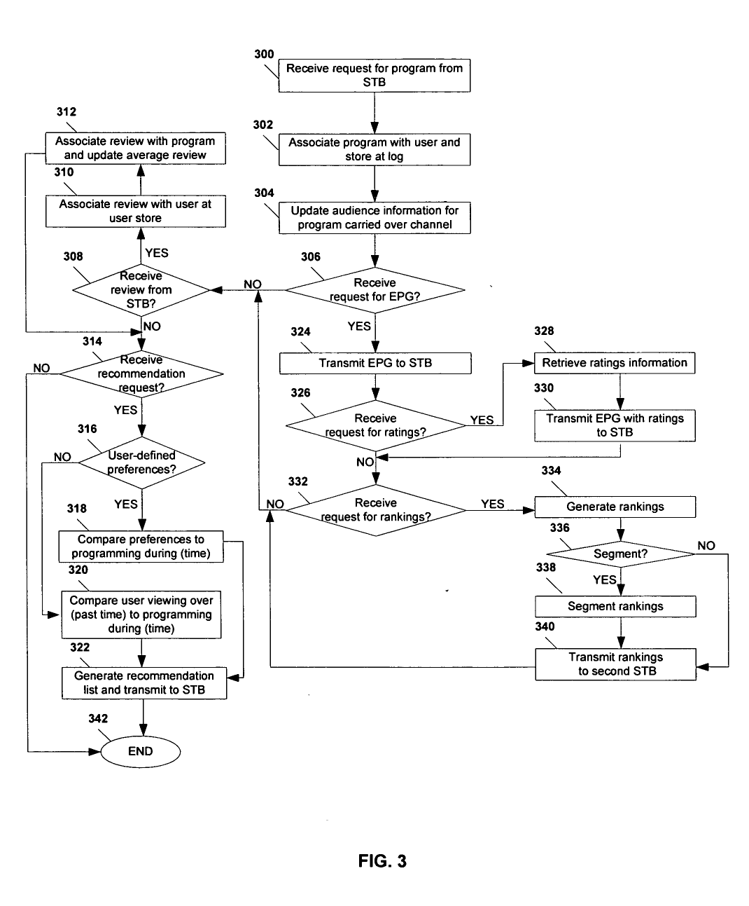

Referring to FIG. 3, a particular embodiment of a method of providing television programming recommendations is disclosed. At block 300, a server receives a request for a television program from a set-top box device. In an illustrative embodiment, the request can be received from the set-top box device at a program information server within an Internet Protocol Television (IPTV) system, such as the program information server 190 illustrated in FIG. 1. Moving to block 302, the server associates the program with the user and stores the user's request of the program in a log. Continuing to block 304, the server can update audience data related to the program carried over the requested channel. In a particular embodiment, the audience data can be a total number of set-top boxes associated with the multicast group of the channel. In another embodiment, the audience data can be a percentage of total set-top boxes within a market area that are associated with the multicast group of the channel. The audience data can be maintained and updated at a multicast server that provides video content carried over the channel. Alternatively, the audience data can be maintained and updated at a server that collects audience data from a plurality of multicast servers.

Proceeding to decision step 306, in a particular embodiment, the server can determine whether it has received a request for an electronic program guide (EPG) from the set-top box device. If the server does not receive a request for an EPG, the method moves to decision step 308, and the server determines whether a user review has been received from the set-top box device. If the server receives a user review, the method continues to block 310, and the server associates the review with the user, the set-top box device, or any combination thereof, and stores the information at a user store. The server can include the user store, or the user store can be external to the server. In a particular embodiment, the method can proceed to block 312, and the server can associate the user review with the reviewed program and store the data, use the data to calculate an average review of the program, or any combination thereof. The method then advances to decision step 314 and continues.

Returning to decision step 308, if the server does not receive a review from the set-top box device, the method proceeds to decision step 314, and the server determines whether it has received a request for television program recommendations from the set-top box device. If the server has not received a request for television program recommendations, the method terminates at 342. On the other hand, if the server has received a request for program recommendations, the method moves to decision step 316, and the server determines whether user-defined preferences are associated with the user or the set-top box device. For example, a user may define programming preferences, such as genres, actors, program types, sport teams, or any combination thereof, via a web portal that communicates with the user store. If user-defined preferences are associated with the user, the set-top box device, or both, the method advances to block 318, and the server compares the user-defined preferences to programs being shown within a period of time after the request, such as 0-2 hours after the request, such that current programs are considered, or 1-2.5 hours, if a user does not wish to switch from a current program. The method then proceeds to block 322, and the server generates a recommendation list that includes titles and other information related to one or more recommended programs that match one or more of the user-defined preferences. The method terminates at 342.

Returning to decision step 316, if the server determines that user-defined preferences are not associated with the user or set-top box device, the method proceeds to block 320. In a particular embodiment, at block 320, the server can compare user viewing at the set-top box device over a period of time prior to the request to programming shown or to be shown within a certain time after the request. In an illustrative embodiment, the server can determine whether programs regularly viewed at the set-top box device are currently showing or will be shown during the next 0-2 hours, for example. The method then proceeds to block 322, and the server generates a recommendation list that includes such programs or programs that share a genre, actor, program type, sport team, or any combination thereof, with the programs that are regularly viewed at the set-top box device. The method terminates at 342.

In a particular embodiment, the server can generate the recommendation list via a recommendation engine that performs the comparison of user preferences to programming. Past and future periods of time used to recommend programming can be predefined or can be user defined.

Returning to decision step 306, if the server receives a request for an EPG, the method moves to block 324, and the server transmits the EPG to the set-top box device. In an illustrative embodiment, the server can be the program information server 190 illustrated in FIG. 1, and the server can push the EPG to the set-top box device, where it can be displayed at a television monitor coupled to the set-top box device. In a particular embodiment, the EPG includes a first indicator of a first selectable option to submit a review. Additionally, the EPG can include a second indicator of a second selectable option to receive programming recommendations. Further, the EPG can include an indicator of a selectable option to view real-time ratings information, such as audience data and average reviews, related to programs included in the EPG. A user can select the indicator at the set-top box device, for example, and the server can receive a request from the set-top box device for real-time ratings information.

Continuing to decision step 326, the server determines whether it has received a request from the set-top box device for real-time ratings information. In a particular embodiment, if the server does not receive a request for real-time ratings information, the method proceeds to decision step 332 and continues. On the other hand, if the server receives a request for real-time ratings information, the method moves to block 328, and the server retrieves audience data and average reviews from its memory device or from one or more other servers, such as the multicast video content servers 180 illustrated in FIG. 1. Continuing to block 330, the server transmits an updated EPG having the real-time ratings information to the set-top box device. The method then proceeds to decision step 332.

In an illustrative embodiment, the EPG can include a fourth indicator of a fourth selectable option to view program rankings according to audience data, for example. A user can select the fourth indicator at the set-top box device, for example, and the server can receive a request from the set-top box device for program rankings. Proceeding to decision step 332, the server determines whether it has received a request for program rankings from the set-top box device. If the server has not received a request for program rankings from the set-top box device, the method proceeds to decision step 308. Conversely, if the server has received a request for program rankings from the set-top box device, the method continues to block 334, and the server generates the program rankings based on the audience data. The method then proceeds to decision step 336.

In one embodiment, the EPG can include a fifth indicator of a fifth selectable option for program rankings that are segmented according to program type. At decision step 336, the server determines whether segmented or non-segmented rankings have been requested. If non-segmented rankings have been requested, the method moves to block 340, and the server transmits the rankings to the set-top box device. On the other hand, if segmented rankings have been requested, the method proceeds to block 338, and program rankings are segmented by program type. The program rankings are then transmitted to the set-top box device at block 340. The method then returns to decision step 308 and continues.

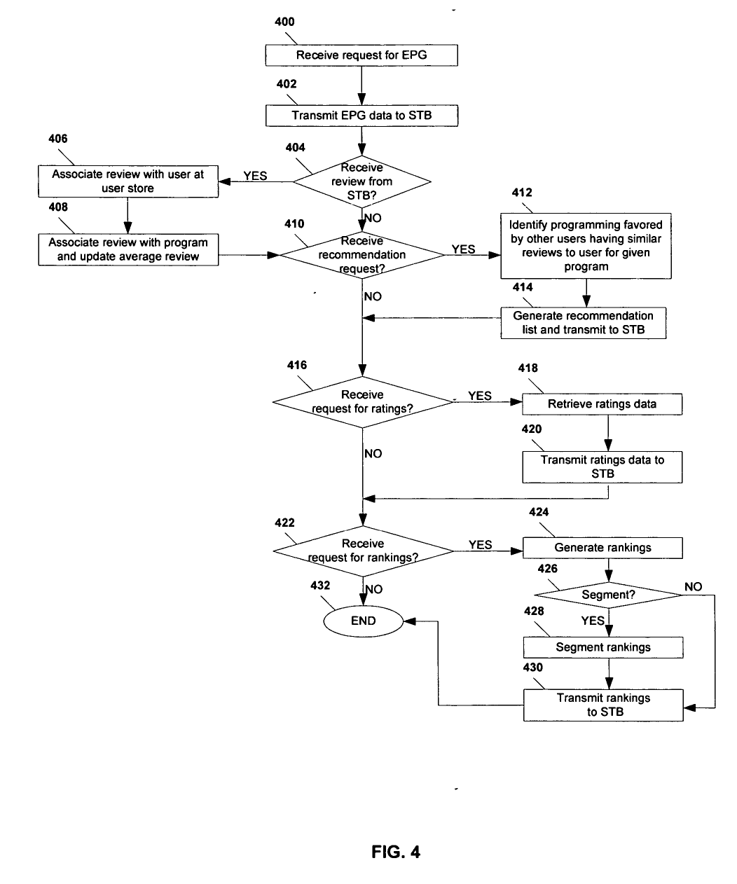

Referring to FIG. 4, a second illustrative embodiment of a method of providing television programming recommendations is illustrated. At block 400, a server receives a request from a set-top box device for data related to an electronic program guide (EPG). In an illustrative embodiment, the request can be received from the set-top box device at a program information server within an Internet Protocol Television (IPTV) system, such as the program information server 190 illustrated in FIG. 1. Moving to block 402, the server can transmit the EPG data to the set-top box device. In an illustrative embodiment, the set-top box device can generate an EPG from the data and transmit it to a display device, such as a television monitor coupled to the set-top box device.

In a particular embodiment, the EPG includes a first indicator of a first selectable option to submit a review. Additionally, the EPG can include a second indicator of a second selectable option to receive programming recommendations. Further, the EPG can include an indicator of a selectable option to view real-time ratings information, such as audience data and average reviews, related to programs included in the EPG. A user can select the indicator at the set-top box device, for example, and the server can receive a request from the set-top box device for real-time ratings information.

Continuing to decision step 404, the server determines whether a user review has been received from the set-top box device. If the server receives a user review, the method continues to block 406, and the server associates the review with the user, the set-top box device, or any combination thereof, and stores the information at a user store. The server can include the user store, or the user store can be external to the server. In a particular embodiment, the method can proceed to block 408, and the server can associate the user review with the reviewed program and store the data, use the data to calculate an average review of the program, or any combination thereof. The method then advances to decision step 410 and continues.

Returning to decision step 404, if the server does not receive a review from the set-top box device, the method proceeds to decision step 410, and the server determines whether it has received a request for television programming recommendations from the set-top box device. If the server has not received a request for television programming recommendations, the method moves to decision step 416. On the other hand, in a particular embodiment, if the server has received a request for programming recommendations, the method moves to block 412. At block 412, the server identifies programming favored by other users that have given reviews similar to the user's review of a given program. For instance, the server can identify one or more programs to which the user gave a threshold rating, e.g., three stars or greater. The server can also identify other users who gave the threshold rating to the same program(s). The server can determine other program(s) that the other users also rated at or above the threshold rating or a different threshold rating. The method then proceeds to block 414, and the server generates a recommendation list that includes the other program(s) that the other users also rated at or above the threshold rating or the different threshold rating. The method then advances to decision step 416.

Proceeding to decision step 416, the server determines whether it has received a request from the set-top box device for real-time ratings information. In a particular embodiment, if the server does not receive a request for real-time ratings information, the method continues to decision step 422. On the other hand, if the server receives a request for real-time ratings information, the method moves to block 418, and the server retrieves audience data and average review data from its memory device or from one or more other servers. Continuing to block 420, the server transmits data related to the real-time ratings information to the set-top box device. In a particular embodiment, the set-top box device can pull the data from the server and generate an updated EPG having the real-time ratings information. The method then proceeds to decision step 422.

At decision step 422, the server determines whether it has received a request for program rankings from the set-top box device. If the server has not received a request for program rankings from the set-top box device, the method terminates at 432. Conversely, if the server has received a request for program rankings from the set-top box device, the method continues to block 424, and the server generates the program rankings based on the audience data. The method then proceeds to decision step 426.

At decision step 426, the server determines whether segmented or non-segmented rankings have been requested. If non-segmented rankings have been requested, the method moves to block 430, and the server transmits the rankings to the set-top box device. On the other hand, if segmented rankings have been requested, the method proceeds to block 428, and program rankings are segmented by program type. The program rankings are then transmitted to the set-top box device at block 430. The method terminates at 432.

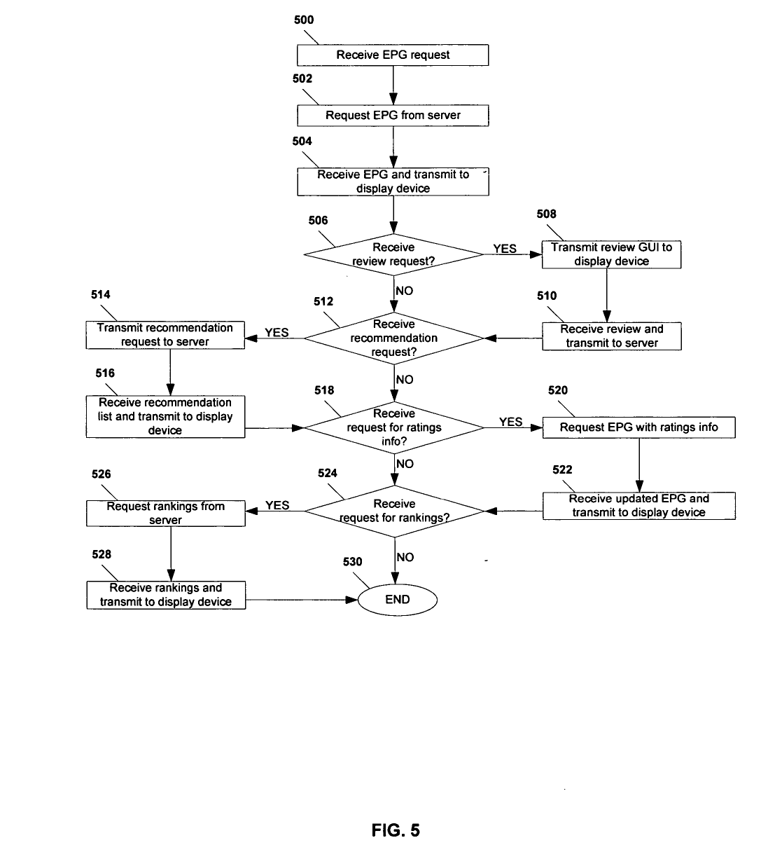

Referring to FIG. 5, an illustrative embodiment of a method of receiving television programming recommendations is illustrated. At block 500, a set-top box device receives a request to view an electronic program guide (EPG) from a user. The method proceeds to block 502, and the set-top box device requests the EPG from a server within an IPTV system. Continuing to block 504, the set-top box receives the EPG from the server and transmits the EPG to a display device, such as a television monitor, coupled to the set-top box device.

Moving to decision step 506, the set-top box device determines whether it has received a request to submit a review of a program. In a particular embodiment, the EPG includes a first indicator of a first selectable option to submit a review. The user can select the first indicator using a review key on a remote control or by using arrow and “enter” keys on the remote control to select the first indicator. If the set-top box does not receive a request from the user to submit a review, the method continues to decision step 512. On the other hand, if the set-top box receives a request from the user to submit a review, the method proceeds to block 508, and the set-top box transmits a graphical user interface (GUI) or other prompt for the review to the display device. The set-top box device can retrieve the GUI or other prompt from the server. In another embodiment, the set-top box device can generate the GUI or other prompt via a review module within a memory of the set-top box device. Advancing to block 510, the set-top box device receives the review and transmits the review to a server via an access network of the IPTV system. The method then proceeds to decision step 512.

At decision step 512, the set-top box device determines whether it has received a request for television program recommendations from the user. In a particular embodiment, the EPG can include a second indicator of a second selectable option to receive program recommendations. The user can select the second indicator using a review key on a remote control or by using arrow and “enter” keys on the remote control to select the second indicator. If the set-top box device does not receive a request for television program recommendations, the method proceeds to decision step 518. Conversely, if the set-top box device receives a request for television programming recommendations, the method moves to block 514, and the set-top box device transmits a recommendation request to the server. The method continues to block 516, and the set-top box device receives a recommendation list having at least one recommended program from the server and transmits the recommendation list to the display device. The method then proceeds to decision step 518.

Proceeding to decision step 518, the set-top box device determines whether it has received a request for real-time ratings information. In a particular embodiment, the EPG includes a third indicator of a selectable option to view real-time ratings information, such as audience data and average reviews related to programs included in the EPG. The user can select the third indicator using a review key on a remote control or by using arrow and “enter” keys on the remote control to select the third indicator. In a particular embodiment, if the server does not receive a request for real-time ratings information, the method moves to decision step 524. On the other hand, if the set-top box device receives a request for real-time ratings information, such as audience data and average reviews, the method continues to block 520, and the set-top box device requests an updated EPG having the real-time ratings information from the server within the IPTV system. The method advances to block 522, and the set-top box device receives the updated EPG having the real-time ratings information and transmits it to the display device. The method then continues to decision step 524.

Proceeding to decision step 524, the set-top box device determines whether it has received a request for program rankings from the set-top box device. In an illustrative embodiment, the EPG can include a fourth indicator of a fourth selectable option to view program rankings according to audience data or review data. The user can select the fourth indicator using a review key on a remote control or by using arrow and “enter” keys on the remote control to select the fourth indicator. If the set-top box device has not received a selection to view program rankings from the user, the method terminates at 530. On the other hand, if the set-top box device has not received a selection to view program rankings from the user, via a remote control device, for example, the method proceeds to block 526, and the set-top box requests the program rankings from the server. The method continues to block 528, and the set-top box device receives the rankings and transmits the rankings to the display device. The method terminates at 530.

Though the aspects of the disclosed methods have been presented in a certain order, for ease of description, certain portions of the method may be performed in a different order or simultaneously. For example, the various determinations of requests for review submissions, programming recommendations, ratings information, or program rankings can be made in any order. Additionally, references to first through fifth indicators of selectable options are for explanatory purposes only. Such indicators can be presented in any order or combination within the EPG or other GUI.

Referring to FIG. 6, an illustrative embodiment of a graphical user interface (GUI) 600 to provide television program recommendations, for example, via ratings information is illustrated. In a particular embodiment, the GUI 600 includes an electronic program guide (EPG) 602. The EPG 602 includes available channels 604 and programs 606 that are carried over each of the available channels 604. In an illustrative embodiment, the EPG can also include audience data 608 related to each program, such as a percentage of set-top box devices receiving each of the programs 606 within a market area, for example. The EPG can also include average reviews 610 of each of the programs 606, such as an average number of stars.

In one embodiment, the GUI 600 can also include a plurality of indicators of selectable options, such as soft buttons 612-620. The soft buttons can be selected, for example, by using arrow keys on a remote control device to manipulate a highlight bar 622 and by pressing an ‘OK,’ ‘ENTER,’ ‘SELECT,’ or similar key on the remote control device, when a desired soft button is highlighted. For example, the GUI can include a ‘RANK PROGRAMS’ indicator 612 of a selectable option to rank programs according audience data. The GUI can also include a ‘SUBMIT REVIEW’ indicator 614 of a selectable option to submit a review of a program. Additionally, the GUI can include a ‘RECOMMEND PROGRAMS indicator 616 of a selectable option to receive program recommendations. Moreover, the GUI can include a ‘DEFINE PREFERENCES’ indicator 618 of a selectable option to submit user program preferences via a set-top box. Further, the GUI can include an ‘EXIT’ indicator 620 of a selectable option to exit the EPG and return to programming.

Referring to FIG. 7, an illustrative embodiment of a graphical user interface (GUI) 700 to provide television program recommendations, for example, via program rankings is illustrated. In a particular embodiment, the GUI 700 includes a program rankings screen 702 that is selectable from an electronic program guide (EPG). In an illustrative embodiment, the program rankings screen 702 can include program rankings that are segmented according to program type. For example, the program rankings section can include a ranked list of programs of a first program type 704, a ranked list of programs of a second program type 706, and ranked lists of programs of other program types. Each ranked list of programs includes the names 708 of the ranked programs. In a particular embodiment, each ranked list can also include audience data 710, for example, corresponding to each program 708.

In one embodiment, the GUI 700 can also include a plurality of indicators of selectable options, such as soft buttons 712-718. The soft buttons can be selected, for example, by using arrow keys on a remote control device to manipulate a highlight bar 720 and by pressing an ‘OK,’ ‘ENTER,’ ‘SELECT,’ or similar key on the remote control device, when a desired soft button is highlighted. For example, the GUI 700 can include a ‘NEXT’ indicator 712 of a selectable option to display a next page of ranked programs. The GUI 700 can also include a ‘PREV’ indicator 714 of a selectable option to display a previous page of ranked programs. Additionally, in an illustrative embodiment, the GUI 700 can include a ‘RANK ALL’ indicator 716 of a selectable option to display non-segmented rankings, i.e., rankings of programs that are not separated according to program type. Further, the GUI 700 can include an ‘EXIT’ indicator 718 of a selectable option to exit the program rankings screen 702 and return to the EPG or to programming.

Referring to FIG. 8, an illustrative embodiment of a graphical user interface (GUI) 800 to receive a program review from a user is illustrated. In a particular embodiment, the GUI 800 includes a review submission screen 802 that can be selectable from an electronic program guide (EPG). In an illustrative embodiment, the review submission screen 802 can include a display of a program 804 that the user is watching. The review submission screen 802 can also include a review portion 806 that the user can use to select a review of the program. In the embodiment shown in FIG. 8, the review portion 806 can include a number of selectable stars.

In a particular embodiment, the GUI 800 can also include a plurality of indicators of selectable options, such as soft buttons 808-814. The soft buttons can be selected, for example, by using arrow keys on a remote control device to manipulate a highlight bar 816 and by pressing an ‘OK,’ ‘ENTER,’ ‘SELECT,’ or similar key on the remote control device, when a desired soft button is highlighted. For example, the GUI 800 can include a ‘HIGHER’ indicator 808 of a selectable option to increase the number of stars that are highlighted in the review section 806. The GUI 800 can also include a ‘LOWER’ indicator 810 of a selectable option to decrease the number of stars that are highlighted in the review section 806. Additionally, in an illustrative embodiment, the GUI 800 can include a ‘SUBMIT’ indicator 812 of a selectable option to display submit the review when the desired number of stars are highlighted in the review section 806. Further, the GUI 800 can include an ‘EXIT’ indicator 814 of a selectable option to exit the review submission screen 802 and return to the EPG or to programming.

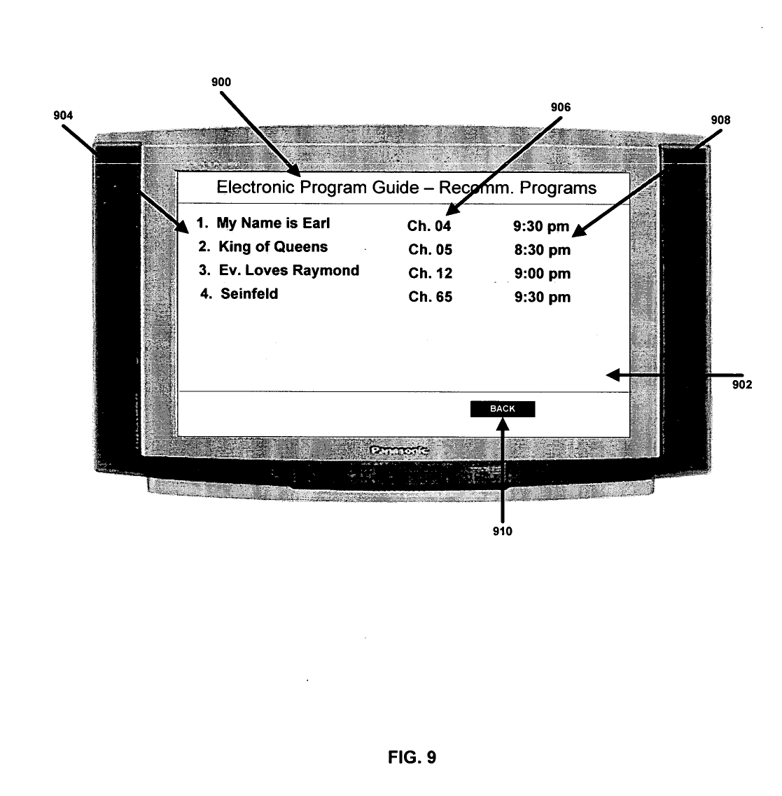

Referring to FIG. 9, an illustrative embodiment of a graphical user interface (GUI) 900 to provide television program recommendations is illustrated. In a particular embodiment, the GUI 900 includes a recommendation list screen 902 that can be requested, for example, via an electronic program guide (EPG). In an illustrative embodiment, the recommendation list screen 902 can include titles or names 904 of one or more recommended programs program rankings. The recommendation list screen 902 can include channels 906 on which the recommended program(s) are shown or to be shown. In a particular embodiment, the recommendation list screen 902 can also include times 908 at which the recommended program(s) are shown or to be shown. In an illustrative, non-limiting embodiment, the recommendation list screen 902 can include an indicator 910 of a selectable option to return to an EPG or other screen.

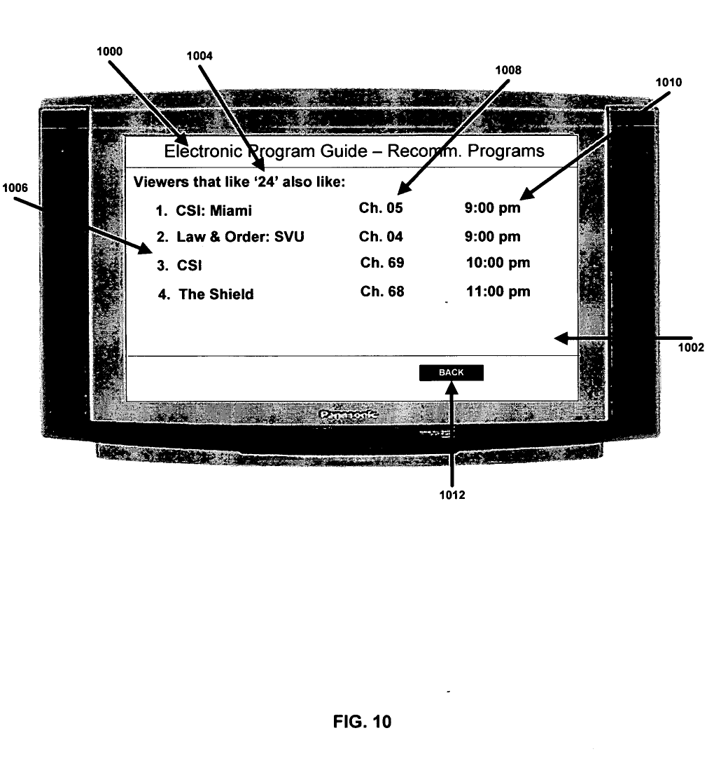

Referring to FIG. 10, a second illustrative embodiment of a graphical user interface (GUI) 1000 to provide television program recommendations is illustrated. In a particular embodiment, the GUI 1000 includes a recommendation list screen 1002 that can be requested, for example, via an electronic program guide (EPG). In an illustrative embodiment, the recommendation list screen 1002 can include a statement 1004 imparting that viewers of a certain program also favor programs 1006 named on a recommendation list. The recommendation list screen 1002 can include titles or names of the programs 1006. The recommendation list screen 1002 can include channels 1008 on which the recommended program(s) 1006 are shown or to be shown. In a particular embodiment, the recommendation list screen 1002 can also include times 1010 at which the recommended program(s) are shown or to be shown. In an illustrative, non-limiting embodiment, the recommendation list screen 1002 can include an indicator 1012 of a selectable option to return to an EPG or other screen.

Referring to FIG. 11, a third illustrative embodiment of a graphical user interface (GUI) 1100 to provide television program recommendations is illustrated. In a particular embodiment, the GUI 1100 includes a recommendation list screen 1102 that can be requested, for example, via an electronic program guide (EPG). In an illustrative embodiment, the recommendation list screen 1102 can include a ‘What's Hot’ list 1104 that includes programs having the highest audience ratings data within a national area, a regional area, a state area, a metropolitan area, a neighborhood area, or any combination thereof. The recommendation list screen 1102 can include titles or names 1106 of one or more recommended programs. The recommendation list screen 1102 can include channels 1108 on which the recommended program(s) are shown or to be shown. In a particular embodiment, the recommendation list screen 1102 can also include pictures 1110 associated with the recommended program(s). In an illustrative, non-limiting embodiment, the recommendation list screen 1102 can include synopses 1112 of the recommended program(s).

Referring to FIG. 12, an illustrative embodiment of a graphical user interface (GUI) 1200 to allow a user to enter programming preferences is illustrated. In a particular embodiment, the GUI 1200 includes a preference selection screen 1202 that is selectable from an electronic program guide (EPG). In an illustrative embodiment, the preference selection screen 1202 can include, for example, a first list 1204 of program types that includes program type names 1206 selectable by a user. The preference selection screen 1202 can also include, for example, a second list 1208 of program names 1210 corresponding to a selected program type, which are selectable by a user to indicate preferred programs. In a particular embodiment, each program type or program name selected by the user can be transmitted by the set-top box device to a server within an Internet Protocol Television (IPTV) system, where it can be stored at a user store. A user can make selections within the GUI 1200 by using arrow keys on a remote control device to manipulate a highlight bar 1214 and by pressing an ‘OK,’ ‘ENTER,’ ‘SELECT,’ or similar key on the remote control device, when a desired selection is highlighted. Further, the GUI 1200 can include an ‘EXIT’ indicator 1212 of a selectable option to exit the preference selection screen 1202 and return to the EPG or to programming.

In conjunction with the configuration of structure described herein, the system and method allow users to interactively submit reviews of programs. For example, the system and method can allow a user to request an EPG that includes an indicator of a selectable option to submit a review of a program. A prompt for the review can be transmitted to a display device coupled to the set-top box device. In one embodiment, users can review programs based on a number of stars. The set-top box device can receive the review and transmit it to a server within the IPTV system. The server can store the review or update an average review of the program associated with the review.

In a particular embodiment, the system and method disclosed provide a user with an ability to request and view television program recommendations. The user can request such recommendations via a remote control device or a second indicator of a second selectable option of an EPG to receive programming recommendations. A set-top box device can receive the request and transmit the request to a server within the IPTV system. In an illustrative embodiment, the server can generate a recommendation list that includes at least one recommended program via a recommendation engine that examines, for example, current and future programming, user-defined preferences, user reviews, reviews of other users, user viewing habits, or any combination thereof.

In a particular embodiment, the system and method disclosed also provide a user with an ability to request and view real-time ratings information related to programs in the EPG that is displayed at a display device coupled to a set-top box device. In a particular embodiment, the EPG can include an indicator of a selectable option to receive the real-time ratings information. An updated EPG that includes the real-time ratings information can be pushed to the set-top box device from a server within an Internet Protocol Television (IPTV) system, in response to a request for real-time ratings information from the set-top box device. Alternatively, data related to the updated EPG can be pulled from the server by the set-top box device, and the set-top box device can generate the updated EPG.

Real-time ratings information can include audience data, such as a number or percentage of set-top boxes in a market area, which are receiving a program or channel. The number or percentage of set-top boxes can be determined based on the sizes of multicast groups associated with each channel and can be updated in response to join commands or leave commands issued by set-top boxes in response to channel change requests. The real-time ratings information can also include average reviews of each program, such as an average number of stars submitted by set-top box users.

Television or video content providers can summarize the audience data and reviews collected using various statistical methods and can compile lists of the most popular television or video programming in real-time. In a particular embodiment, the EPG can include an indicator of a selectable option to view overall program rankings or program rankings that are segmented according to program type. For example, users can view program rankings related to sports, comedy, drama, action, news, documentary, educational, movie, or another program type. Programs can be ranked according to number of viewers or user ratings of each program. Nationwide ranking lists can be adjusted for time zones to improve accuracy for separate market areas. In one embodiment, program rankings can be pushed to a set-top box device in response to a request transmitted by the set-top box device to a server within the IPTV system. In another embodiment, the set-top box device can generate program rankings based on real-time ratings information pulled by the set-top box from a server within the IPTV system.

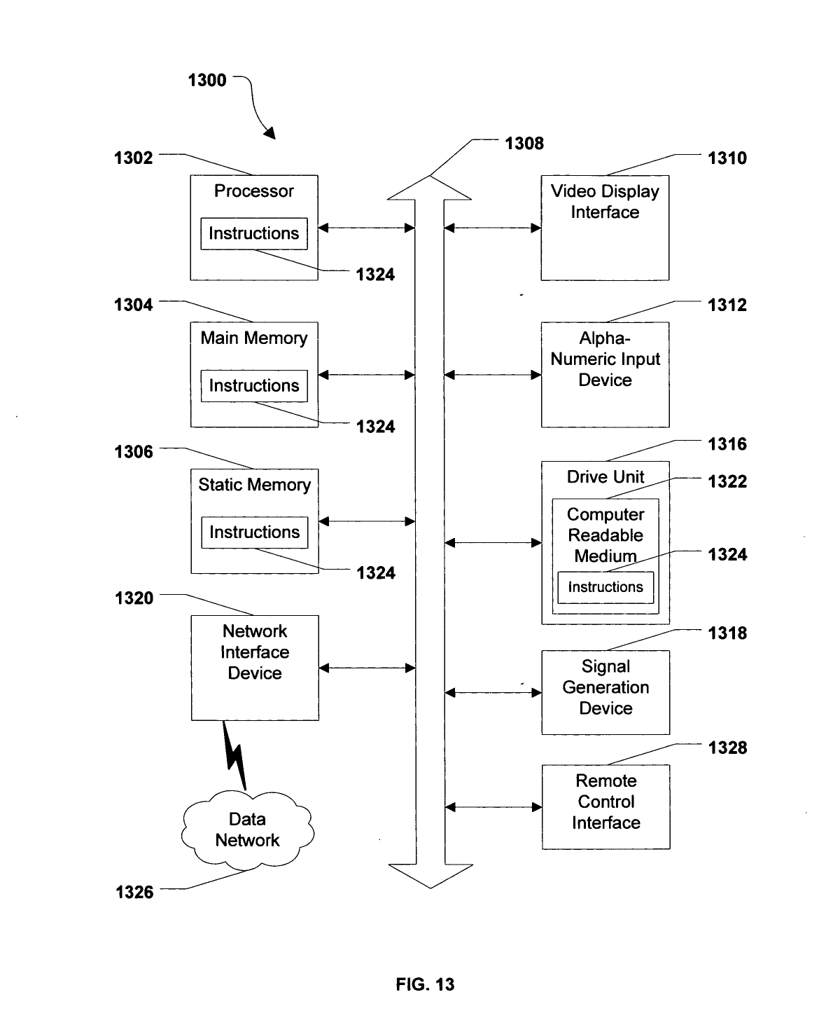

Referring to FIG. 13, an illustrative embodiment of a general computer system is shown and is designated 1300. The computer system 1300 can include a set of instructions that can be executed to cause the computer system 1300, or a portion thereof, to perform any one or more of the methods or computer based functions disclosed herein in connection with the set-top box device or with a network device. The computer system 1300, or any portion thereof, may operate as a standalone device or may be a hardware or software module within a server or set-top box device, as illustrated in FIGS. 1 and 2.

In a networked deployment, the computer system may operate in the capacity of a server within an IPTV system or a set-top box device communicating therewith. The computer system 1300 can also be implemented as or incorporated into various other devices, or any other machine capable of executing a set of instructions (sequential or otherwise) that specify actions to be taken by that machine. In a particular embodiment, the computer system 1300 can be implemented using electronic devices that provide audio, video or data communication. Further, while a single computer system 1300 is illustrated, the term “system” shall also be taken to include any collection of systems or sub-systems that individually or jointly execute a set, or multiple sets, of instructions to perform one or more computer functions, such as the IPTV system illustrated in FIG. 1.

As illustrated in FIG. 13, the computer system 1300 may include a processor 1302, e.g., a central processing unit (CPU), a graphics-processing unit (GPU), or both. Moreover, the computer system 1300 can include a main memory 1304 and a static memory 1306 that can communicate with each other via a bus 1308. As shown, the computer system 1300 may further include a video display unit 1310, such as a liquid crystal display (LCD), an organic light emitting diode (OLED), a flat panel display, a solid state display, or a cathode ray tube (CRT). Additionally, the computer system 1300 may include an input device 1312, such as a remote control input, an input control panel, a keyboard, a mouse, a gaming station input, or one or more keys disposed on a set-top box device. The computer system 1300 can also include a disk drive unit 1316, a signal generation device 1318, such as a speaker, and a network interface device 1320.

In an illustrative embodiment, the computer system 1300 can include a remote control interface 1328, such as the remote control interface 216 of the set-top box device illustrated in FIG. 2. The remote control interface 1328 can receive inputs from a remote control device.

In a particular embodiment, as depicted in FIG. 13, the disk drive unit 1316 may include a computer-readable medium 1322 in which one or more sets of instructions 1324, e.g. software, can be embedded. Further, the instructions 1324 may embody one or more of the methods or logic as described herein. In a particular embodiment, the instructions 1324 may reside completely, or at least partially, within the main memory 1304, the static memory 1306, and/or within the processor 1302 during execution by the computer system 1300. The main memory 1304 and the processor 1302 also may include computer-readable media.

In an alternative embodiment, dedicated hardware implementations, such as application specific integrated circuits, programmable logic arrays and other hardware devices, can be constructed to implement one or more of the methods described herein. Applications that may include the apparatus and systems of various embodiments can broadly include a variety of electronic and computer systems. One or more embodiments described herein may implement functions using two or more specific interconnected hardware modules or devices with related control and data signals that can be communicated between and through the modules, or as portions of an application-specific integrated circuit. Accordingly, the present system encompasses software, firmware, and hardware implementations.

In accordance with various embodiments of the present disclosure, the methods described herein may be implemented by software programs executable by a computer system. Further, in an exemplary, non-limited embodiment, implementations can include distributed processing, component/object distributed processing, and parallel processing. Alternatively, virtual computer system processing can be constructed to implement one or more of the methods or functionality as described herein.

The present disclosure contemplates a computer-readable medium that includes instructions 1324 or receives instructions 1324 responsive to a propagated signal, so that a device connected to a network 1326 can communicate audio, video or data over the network 1326. Further, the instructions 1324 may be transmitted or received over the network 1326 via the network interface device 1320.

While the computer-readable medium is shown to be a single medium, the term “computer-readable medium” includes a single medium or multiple media, such as a centralized or distributed database, and/or associated-caches and servers that store one or more sets of instructions. The term “computer-readable medium” shall also include any medium that is capable of storing, encoding or carrying a set of instructions for execution by a processor or that cause a computer system to perform any one or more of the methods or operations disclosed herein.

In a particular non-limiting, exemplary embodiment, the computer-readable medium can include a solid-state memory such as a memory card or other package that houses one or more non-volatile read-only memories. Further, the computer-readable medium can be a random access memory or other volatile re-writable memory. Additionally, the computer-readable medium can include a magneto-optical or optical medium, such as a disk or tapes or other storage device to capture carrier wave signals such as a signal communicated over a transmission medium. A digital file attachment to an e-mail or other self-contained information archive or set of archives may be considered a distribution medium that is equivalent to a tangible storage medium. Accordingly, the disclosure is considered to include any one or more of a computer-readable medium or a distribution medium and other equivalents and successor media, in which data or instructions may be stored.

Although the present specification describes components and functions that may be implemented in particular embodiments with reference to particular standards and protocols, the invention is not limited to such standards and protocols. For example, standards for Internet and other packet switched network transmission (e.g., TCP/IP, UDP/IP, HTML, HTTP) represent examples of the state of the art. Such standards are periodically superseded by faster or more efficient equivalents having essentially the same functions. Accordingly, replacement standards and protocols having the same or similar functions as those disclosed herein are considered equivalents thereof.

The illustrations of the embodiments described herein are intended to provide a general understanding of the structure of the various embodiments. The illustrations are not intended to serve as a complete description of all of the elements and features of apparatus and systems that utilize the structures or methods described herein. Many other embodiments may be apparent to those of skill in the art upon reviewing the disclosure. Other embodiments may be utilized and derived from the disclosure, such that structural and logical substitutions and changes may be made without departing from the scope of the disclosure. Additionally, the illustrations are merely representational and may not be drawn to scale. Certain proportions within the illustrations may be exaggerated, while other proportions may be minimized. Accordingly, the disclosure and the figures are to be regarded as illustrative rather than restrictive.

One or more embodiments of the disclosure may be referred to herein, individually and/or collectively, by the term “invention” merely for convenience and without intending to voluntarily limit the scope of this application to any particular invention or inventive concept. Moreover, although specific embodiments have been illustrated and described herein, it should be appreciated that any subsequent arrangement designed to achieve the same or similar purpose may be substituted for the specific embodiments shown. This disclosure is intended to cover any and all subsequent adaptations or variations of various embodiments. Combinations of the above embodiments, and other embodiments not specifically described herein, will be apparent to those of skill in the art upon reviewing the description.

The Abstract of the Disclosure is provided to comply with 37 C.F.R. §1.72(b) and is submitted with the understanding that it will not be used to interpret or limit the scope or meaning of the claims. In addition, in the foregoing Detailed Description, various features may be grouped together or described in a single embodiment for the purpose of streamlining the disclosure. This disclosure is not to be interpreted as reflecting an intention that the claimed embodiments require more features than are expressly recited in each claim. Rather, as the following claims reflect, inventive subject matter may be directed to less than all of the features of any of the disclosed embodiments. Thus, the following claims are incorporated into the Detailed Description, with each claim standing on its own as defining separately claimed subject matter.

The above-disclosed subject matter is to be considered illustrative, and not restrictive, and the appended claims are intended to cover all such modifications, enhancements, and other embodiments, which fall within the true spirit and scope of the present invention. Thus, to the maximum extent allowed by law, the scope of the present invention is to be determined by the broadest permissible interpretation of the following claims and their equivalents, and shall not be restricted or limited by the foregoing detailed description.

What is claimed is:

1. A method of providing television program recommendations, the method comprising:
receiving a user review of a television program from a set-top box device via an access network of an Internet Protocol Television (IPTV) system;
associating the user review with a user of the set-top box device;
receiving a request for programming recommendations from the set-top box device; and
generating a recommendation list that includes at least one recommended program.

2. The method of claim 1, further comprising:
comparing at least one user-defined preference with a plurality of programs shown during a period of time after the request, wherein the at least one user-defined preference is received via a web portal; and
wherein the at least one recommended program has a type, a genre, an actor, a sport team, or any combination thereof, in common with the at least one user-defined preference.

3. The method of claim 1, further comprising:
determining a type of each of a plurality of programs viewed by the user during a period of time before the request;
determining a subset of the plurality of programs, wherein each program in the subset received a review score from the user that is greater than or equal to a threshold review score;
identifying at least one other program shown during a period of time after the request, wherein the at least one other program shares a type, a genre, an actor, a sport team, or any combination thereof, with at least one program in the subset; and
wherein the recommendation list includes the at least one other program.

4. The method of claim 1, further comprising:
determining that the user review is greater than or equal to a threshold review score;
identifying at least one other user that submitted a review of the television program that was greater than or equal to the threshold review score;
identifying at least one second program reviewed by the at least one other user, wherein the at least one other user submitted a second review of the second program that was greater than or equal to a second threshold review score; and
wherein the recommendation list includes the at least one second program.

5. The method of claim 1, further comprising:
determining aggregated audience data related to a plurality of television programs;
selecting at least one most watched program from the plurality of television programs; and
wherein the recommendation list includes the at least one most watched program.

6. The method of claim 5, further comprising:
comparing the at least one most watched program with at least one program viewed by the user within a period of time before the request; and
wherein the recommendation list includes at least one matching program, wherein the at least one most watched program and the at least one program viewed by the user each include the at least one matching program.

7. The method of claim 1, further comprising:
determining at least one program viewed by the user within a period of time before the request;
comparing the at least one program viewed by the user with a plurality of programs shown during a period of time after the request; and
wherein the recommendation list includes at least one matching program, wherein the plurality of programs and the at least one program viewed by the user include the at least one matching program.

8. The method of claim 1, further comprising:
receiving a request from the set-top box device for an electronic program guide (EPG);
generating the EPG, wherein the EPG includes a first indicator of a first selectable option to submit the user review and a second indicator of a second selectable option to receive the recommendation list; and
transmitting the EPG to the set-top box device.

9. The method of claim 8, further comprising:
receiving a first command from the set-top box device, the first command related to a selection of the second indicator; and
transmitting the recommendation list to the set-top box device via the access network.

10. The method of claim 8, further comprising:
receiving an other command from the set-top box device, the other command related to a selection of a third indicator of a third selectable option of the EPG to receive real-time ratings information;
updating the EPG to include the real-time ratings information; and
transmitting the updated EPG to the set-top box device.

11. The method of claim 10, wherein the real-time ratings information includes aggregated audience data associated with at least one program displayed via the EPG, an average review score associated with at least one program displayed via the EPG, or any combination thereof.

12. The method of claim 11, wherein the aggregated audience data associated with a program displayed via the EPG is determined based at least partially on the size of a multicast group of a channel showing the program associated with the aggregated audience data.

13. The method of claim 11, further comprising:
receiving a separate command from the set-top box device, the separate command related to a selection of a fourth indicator of a fourth selectable option on the EPG to receive a ranked list of programs;
comparing the aggregated audience data of the program to other aggregated audience data of each of a plurality of other programs;
arranging the program and the plurality of other programs into a ranked list based on the aggregated audience data and the other aggregated audience data; and
transmitting the ranked list to the set-top box device.

14. The method of claim 13, further comprising:
receiving an additional command from the set-top box device, the additional command related to a selection of a fifth indicator of a fifth selectable option of the EPG;
arranging the ranked list into a plurality of segments in response to the additional command, wherein each of the plurality of segments includes programs of a program type; and
transmitting a segmented ranked list that includes the at least one segment to the set-top box device.

15. The method of claim 11, wherein the aggregated audience data includes a percentage of end user devices within a national area, a regional area, a state area, a metropolitan area, a neighborhood area, or any combination thereof.

16. The method of claim 1, wherein the user review includes a number of stars.

17. A method of receiving television program recommendations, the method comprising:
submitting a user review of a television program to a server via an access network of an Internet Protocol Television (IPTV) system, wherein the review is associated with the user at the server;
issuing a request for programming recommendations to the server via the access network; and
receiving a recommendation list via the access network, wherein the recommendation list includes at least one recommended program.

18. The method of claim 17, further comprising:
receiving a selection to view an electronic program guide (EPG);
issuing a request to the server for data related to the EPG;
receiving the data from the server; and
generating the EPG, wherein the EPG includes a first indicator of a first selectable option to submit the user review and a second indicator of a second selectable option to receive the recommendation list.

19. The method of claim 17, further comprising:
receiving a first command related to a selection of the first indicator; and
prompting the user to input the user review in response to the first command.

20. The method of claim 17, further comprising receiving a second command related to a selection of the second indicator before issuing the request to receive the recommendation list.

21. The method of claim 18, wherein the EPG includes a third indicator of a third selectable option to receive real-time ratings information.

22. The method of claim 21, further comprising:
receiving a third command related to a selection of the third indicator;
requesting data related to the real-time ratings information;
receiving data related to the real-time ratings information; and
diaplaying an updated EPG that includes the real-time ratings information.

23. A system to provide television program recommendations, the system comprising:
a server within an Internet Protocol Television (IPTV) system, the server having a processor and a memory device accessible to the processor;
wherein the memory device includes a user store that is configured to store a review of a television program received from a set-top box device and to associate the review with a user of the set-top box device;
wherein the memory device includes a recommendation engine that is executable by the processor to generate a recommendation list that includes at least one recommended program; and
wherein the server is configured to transmit the recommendation list to the set-top box device via an access network of the IPTV system.

24. The system of claim 23, wherein the recommendation list is generated in response to a request for programming recommendations received from the set-top box device.

25. The system of claim 23, wherein: the user store is configured to receive at least one user-defined preference via a web portal;
the recommendation engine is executable by the processor to compare the at least one user-defined preference with a plurality of programs shown during a period of time after the request; and
wherein the at least one recommended program has a type, a genre, an actor, a sport team, or any combination thereof, in common with the at least one user-defined preference.

26. The system of claim 23, wherein:
the recommendation engine is executable by the processor to:
determine a type of each of a plurality of programs reviewed by the user during a period of time before the request;
determine a subset of the plurality of programs, wherein each program in the subset received a review score from the user that is greater than or equal to a threshold review score;
identify at least one other program shown during a period of time after the request, wherein the at least one other program shares a type, a genre, an actor, a sport team, or any combination thereof, with at least one program in the subset; and
the recommendation list includes the at least one other program.

27. The system of claim 23, wherein:
the recommendation engine is executable by the processor to:
determine that the user review is greater than or equal to a threshold review score;
identify at least one other user that submitted a review of the television program that was greater than or equal to the threshold review score;
identify at least one second program reviewed by the at least one other user, wherein the at least one other user submitted a second review of the second program that was greater than or equal to a second threshold review score; and
the recommendation list includes the at least one second program.

28. A system to receive television program recommendations, the system comprising:
a set-top box having a processor and a memory device accessible to the processor;
wherein the memory device includes a review module that is executable by the processor to submit a user review of a television program to a server via an Internet Protocol Television (FPTV) system, wherein the review is associated with the user;
wherein the memory device includes a recommendation module that is executable by the processor to issue a request via the IPTV system to receive programming recommendations; and
wherein the recommendation module is configured to transmit a recommendation list to a display device coupled to the set-top box device, the recommendation list including at least one recommended program.

29. The system of claim 28, wherein:
the memory device includes an electronic program guide (EPG) module that is executable by the processor to generate an EPG from EPG data received in response to a request from the set-top box device;
the EPG includes a first indicator of a first selectable option to receive the recommendation list and a second indicator of a second selectable option to receive real-time ratings information; and
the EPG module is executable by the processor to transmit the EPG to the set-top box device.

30. A computer program embedded in a computer-readable medium, the computer program comprising:
instructions to store a review of a television program received from a set-top box device and to associate the review with a user of the set-top box device;
instructions to generate a recommendation list that includes at least one recommended program, in response to a request for programming recommendations received from the set-top box device; and
instructions to transmit the recommendation list to the set-top box device via an access network of an Internet Protocol Television (IPTV) system.

31. A computer program embedded in a computer-readable medium, the computer program comprising:
instructions to submit a user review of a television program to a server via an access network of an Internet Protocol Television (IPTV) system;
instructions to issue a request to the server via the access network to receive programming recommendations; and
instructions to transmit a recommendation list received from the server to a display device coupled to the set-top box device, the recommendation list including at least one recommended program.
